(19) United States
(12) Patent Application Publication
(10) Pub. No.: US 2003/0069047 A1
(43) Pub. Date: Apr. 10, 2003

(54) Adaptive array antenna directivity control system

(76) Inventor: Minako Kitahara, Tokyo (JP)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/265,763

(22) Filed: Oct. 8, 2002

(30) Foreign Application Priority Data
Oct. 10, 2001 (JP) P.2001-312888

(51) Int. Cl. H04B 1/10; H04B 15/00; H04B 1/00; H04B 1/06; H04B 7/00; H04M 1/00; H04B 1/38

(52) U.S. Cl. 455/562; 455/63; 455/132; 455/272

(57) ABSTRACT

To provide an adaptive array antenna directivity control system that can select a path optimum for communication depending on the state of communication with a mobile station, and improve an interference removing effect.

The adaptive array antenna directivity control system measures power values and arrival angles of signals of respective paths received at a plurality of antenna elements constituting an adaptive array antenna provided in a CDMA base station, selects a transmission wishing path based on the measurement results, executes a weight control relative to signals to be transmitted from the respective antenna elements based on the foregoing measurement results, and radio-outputs the signals as transmission signals.

### BACKGROUND OF THE INVENTION

1. Field of the Invention

The present invention relates to a directivity control system of an adaptive array antenna in a radio base station that performs radio communication with a mobile station and, in particular, relates to a directivity control system of an adaptive array antenna that can remove interference according to the state of communication with a mobile station.

2. Description of the Related Art

In the radio communication system according to CDMA (Code Division Multiple Access), a base station despreads a signal radio-transmitted from a mobile station using a spreading code allocated per mobile station, thereby to demodulate the signal, while spread-modulates a signal to be transmitted to a mobile station to perform radio transmission.

In the radio communication system according to CDMA, the radio communication sharing the same frequency band by a plurality of mobile stations can be carried out using spreading codes.

However, because the same frequency band is shared by the plurality of mobile stations, it is possible that a radio signal used in communication with a certain mobile station becomes a signal that interferes with a signal of another mobile station, i.e. an interference signal.

Similarly, due to multi-paths wherein a radio signal used in communication with the same mobile station is transmitted or received via a plurality of paths, a signal in another path becomes an interference signal to cause interference.

As means for removing interference caused by a signal of another mobile station or multi-paths, it has been proposed to provide an adaptive array antenna in a base station of the CDMA communication system. The adaptive array antenna comprises a plurality of antenna elements and is capable of transmitting and receiving radio waves in specific directions. Specifically, in the adaptive array antenna, transmission and reception of radio waves in specific directions are made possible based on a system that controls the directivity upon transmission and reception by giving transmission and reception weights to the respective antenna elements (hereinafter, this system will be referred to as “adaptive array antenna directivity control system”).

Using the foregoing system, the adaptive array antenna specifies a path of a signal wishing communication with a mobile station (hereinafter, this path will be referred to as “wishing path”), and implements communication with the mobile station while avoiding interference with the wishing path.

However, in the foregoing conventional adaptive array antenna directivity control system, there has been a problem that the interference can not be fully removed, as will be explained hereinbelow.

The W-CDMA (Wide-band Code Division Multiple Access) that has been introduced as the next generation mobile communication system is characterized by offering a multi-rate service covering wide-range transmission speeds from high-speed data communication to low-speed audio communication.

However, the high-speed data communication in the W-CDMA has a low spreading ratio, and thus is very weak against interference. In view of this, it has further been proposed to use an adaptive array antenna for removing interference in the W-CDMA radio communication system.

However, even if the adaptive array antenna is used, when a path of an interference signal (hereinafter referred to as “interference path”) exists in the neighborhood of a wishing path, it is difficult to remove the interference due to lowering of the main lobe level caused by gain reduction of the interference path, thereby to deteriorate the communication characteristics of the antenna.

On the other hand, in the selection of the wishing path in the adaptive array antenna, a path of a leading wave being a signal that has first reached the base station or a path of a signal having the largest power value has been determined as a wishing path. However, it is not necessarily the best depending on a positional relationship between the mobile station and the path, or the power value of the signal, so that the wishing path is subjected to an influence of interference as in the foregoing examples or the like, thereby to deteriorate the communication characteristics of the antenna.

### SUMMARY OF THE INVENTION

The present invention has been made in view of the foregoing circumstances, and has an object to provide an adaptive array antenna directivity control system that can select a wishing path according to the state of communication with a mobile station, thereby to improve an interference removing effect of an adaptive array antenna.

For solving the foregoing problems of the prior art, according to the present invention, there is provided an adaptive array antenna directivity control system that controls directivity of an adaptive array antenna provided in a radio base station, and causes signals from a mobile station received at a plurality of antenna elements constituting the adaptive array antenna, to have weights corresponding to the respective antenna elements so as to reduce interference relative to a reception wishing path optimum for receiving signals from the mobile station, wherein paths are detected from the signals received at the antenna elements, a power value and an arrival angle are calculated for each of the detected paths, the reception wishing path is selected from the detected paths based on at least one of the power values and the arrival angles, the weight for reducing the interference relative to the reception wishing path is derived for each of the antenna elements, and the signals received at the antenna elements are multiplied by the corresponding weights. Therefore, the reception wishing path can be selected depending on the state of communication with the mobile station, thereby to improve an interference removing effect of the adaptive array antenna.

According to the present invention, there is also provided an adaptive array antenna directivity control system that controls directivity of an adaptive array antenna provided in a radio base station, and causes signals from a mobile station received at a plurality of antenna elements constituting the adaptive array antenna, to have weights corresponding to the respective antenna elements so as to reduce interference relative to a transmission wishing path optimum for transmitting signals to the mobile station, wherein paths are detected from the signals received at the antenna elements, a power value and an arrival angle are calculated for each of the detected paths, the transmission wishing path is selected from the detected paths based on at least one of the power values and the arrival angles, the weight for reducing the interference relative to the transmission wishing path is derived for each of the antenna elements, and the signals to be transmitted from the antenna elements are multiplied by the corresponding weights. Therefore, the transmission wishing path can be selected depending on the state of communication with the mobile station, thereby to improve an interference removing effect of the adaptive array antenna.

### BRIEF DESCRIPTION OF THE DRAWINGS

FIG. 1 is a structural block diagram of an adaptive array antenna directivity control system corresponding to an up line, according to an embodiment of the present invention.

FIG. 2 is a structural block diagram of an adaptive array antenna directivity control system corresponding to a down line, according to an embodiment of the present invention.

FIG. 3 is a structural block diagram of an angle estimating section and a structure necessary for angle estimation in the adaptive array antenna directivity control system according to the embodiment of the present invention.

FIG. 4 is a cumulative frequency distribution diagram of total transmission power values according to the prior art and the adaptive array antenna directivity control system of the present invention.

FIG. 5 is a diagram showing a wishing path selection method implemented in the up-line directivity control system.

FIG. 6 is a diagram showing a wishing path selection method implemented in the down-line directivity control system.

FIG. 7 is a diagram showing a wishing path selection method implemented in the down-line directivity control system.

FIG. 8 is a diagram showing methods of selecting wishing paths for the first two users in the adaptive array antenna directivity control system of the present invention.

FIG. 9 is a diagram showing a method of selecting wishing paths for three users in the adaptive array antenna directivity control system of the present invention.

### DESCRIPTION OF REFERENCE NUMERALS

11, 21 . . . antenna, 12, 22 . . . RF receiver, 13, 23 . . . received data processing section, 14, 24 . . . weight control section, 15, 25, 343 . . . multiplier, 16, 345 . . . adder, 26 . . . RF transmitter, 27 . . . distributor, 34, 133, 233 . . . angle estimating section, 131, 231 . . . path detecting section, 132, 232 . . . power measuring section, 134, 234 . . . path selecting section, 342 . . . symbol detecting section, 346 . . . angle calculating section

### DESCRIPTION OF THE PREFERRED EMBODIMENT

Preferred embodiments of the present invention will be described hereinbelow with reference to the accompanying drawings.

An adaptive array antenna directivity control system according to the embodiment of the present invention measures power values and arrival angles of signals of respective paths received at a plurality of antenna elements constituting an adaptive array antenna provided in a CDMA base station, selects a wishing path based on the measurement results, executes a weight control relative to the received signals based on the foregoing measurement results, and outputs the sum of the weight-controlled signals as a received signal. With this arrangement, the optimum wishing path can be selected in the up line, thereby to improve an effect of removing interference caused by an interference path.

Another adaptive array antenna directivity control system according to the embodiment of the present invention measures power values and arrival angles of signals of respective paths received at a plurality of antenna elements constituting an adaptive array antenna provided in a CDMA base station, selects a wishing path based on the measurement results, executes a weight control relative to signals to be transmitted from the respective antenna elements based on the foregoing measurement results, and radio-outputs the signals as transmission signals. With this arrangement, the optimum wishing path can be selected in the down line, thereby to improve an effect of removing interference caused by an interference path, and decrease the transmission power.

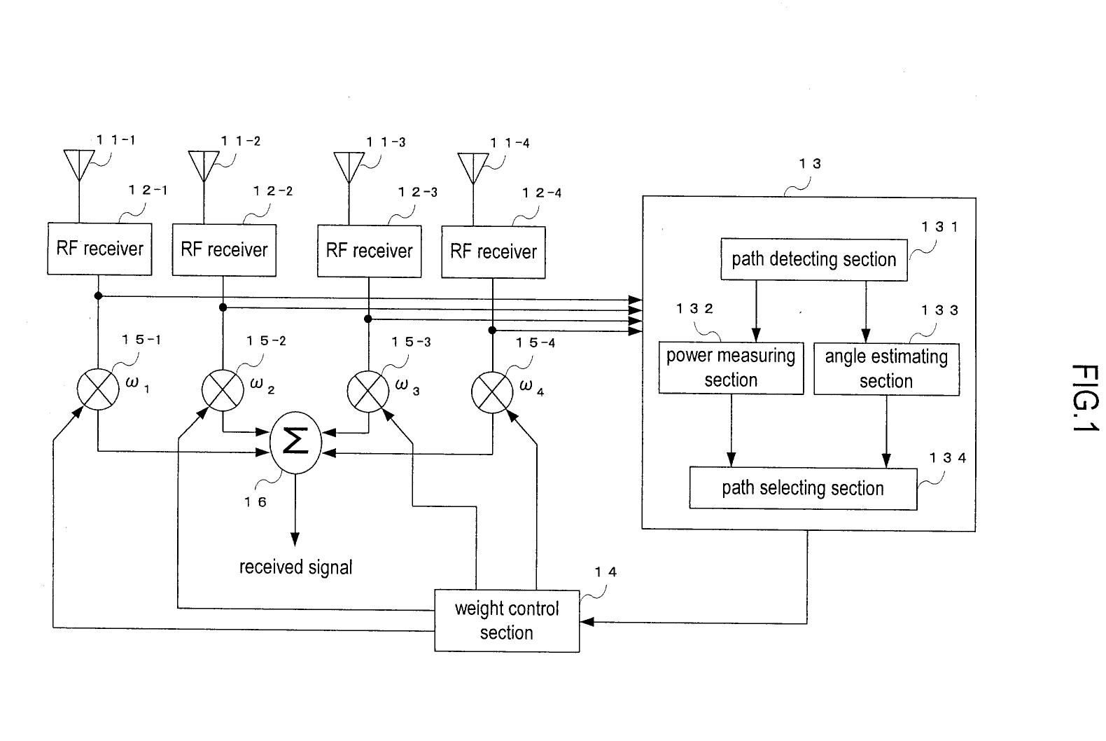

A structure of the adaptive array antenna directivity control system of the embodiment of the present invention will be described referring to FIGS. 1 to 3. FIG. 1 is a structural block diagram of an adaptive array antenna directivity control system corresponding to an up line, according to the embodiment of the present invention.

In a CDMA communication base station, the adaptive array antenna directivity control system of FIG. 1 (hereinafter referred to as “directivity control system of FIG. 1”) measures power values and arrival angles of signals of respective paths received at a plurality of antennas, and selects a wishing path based on the measurement results, and further, multiplies the received signals by weights derived at a weight control section for the respective antennas, and outputs the sum of the multiplication results as a received signal. The directivity control system of FIG. 1 comprises four antennas, and implements the path selection and weight control based on signals received at the respective antennas. However, the number of antennas may have a different value.

The directivity control system of FIG. 1 comprises antennas 11-1 to 11-4, RF (Radio Frequency) receivers 12-1 to 12-4, a received data processing section 13, a weight control section 14, multipliers 15-1 to 15-4, an adder 16 and a symbol detecting section (not shown).

The received data processing section 13 comprises a path detecting section 131, a power measuring section 132, an angle estimating section 133 and a path selecting section 134.

Now, the respective elements of the directivity control system of FIG. 1 will be described.

The antennas 11-1 to 11-4 are directional antenna elements constituting an adaptive array antenna and, when spread-modulated signals radio-transmitted from mobile stations are received, the antennas 11-1 to 11-4 output the received signals to the RF receivers 12-1 to 12-4 provided correspondingly thereto. For accomplishing wide-range communication with mobile stations, the antennas 11-1 to 11-4 may be arranged in a lattice shape or circumferentially at regular intervals, or may be arranged in other fashions.

The RF receivers 12-1 to 12-4 frequency-convert the signals received at the antennas 11-1 to 11-4 from an RF band to a BB (BaseBand), and output them to the multipliers 15-1 to 15-4 corresponding to the RF receivers, respectively, and further to the received data processing section 13.

The received data processing section 13 detects paths from the BB signals output from the RF receivers 12-1 to 12-4, measures power values and arrival angles of the detected paths, and selects a wishing path based on the measurement results. Further, the received data processing section 13 outputs to the weight control section 14 necessary information among the path detection results, the power value measurement results, the arrival angle measurement results and the wishing path selection result.

Now, the respective elements constituting the received data processing section 13 will be described.

When the signals received at the respective antennas are input to the received data processing section 13, the path detecting section 131 performs despread processing to detect arrival timings, thereby to detect paths. The despread processing results at the respective paths are output to the power measuring section 132, the angle estimating section 133 and the weight control section 14 as despread signals including information of the arrival timings.

The path detecting section 131 stores despreading codes corresponding to the received signals. On the other hand, it may also be arranged that means for producing despreading codes is separately provided, and the path detecting section 131 performs despreading calculations using the produced despreading codes and the signals.

The power measuring section 132 measures power values of the signals at the respective paths based on the input despread signals, and outputs them to the path selecting section 134 and the weight control section 14 as path power value information.

The angle estimating section 133 estimates arrival angles of the signals at the respective paths based on the input despread signals, and outputs them to the path selecting section 134 and the weight control section 14 as path arrival angle information.

The path selecting section 134 selects a wishing path from the detected paths based on at least one of the input path power value information and path arrival angle information, and outputs the selection result to the weight control section 14 as selected path information.

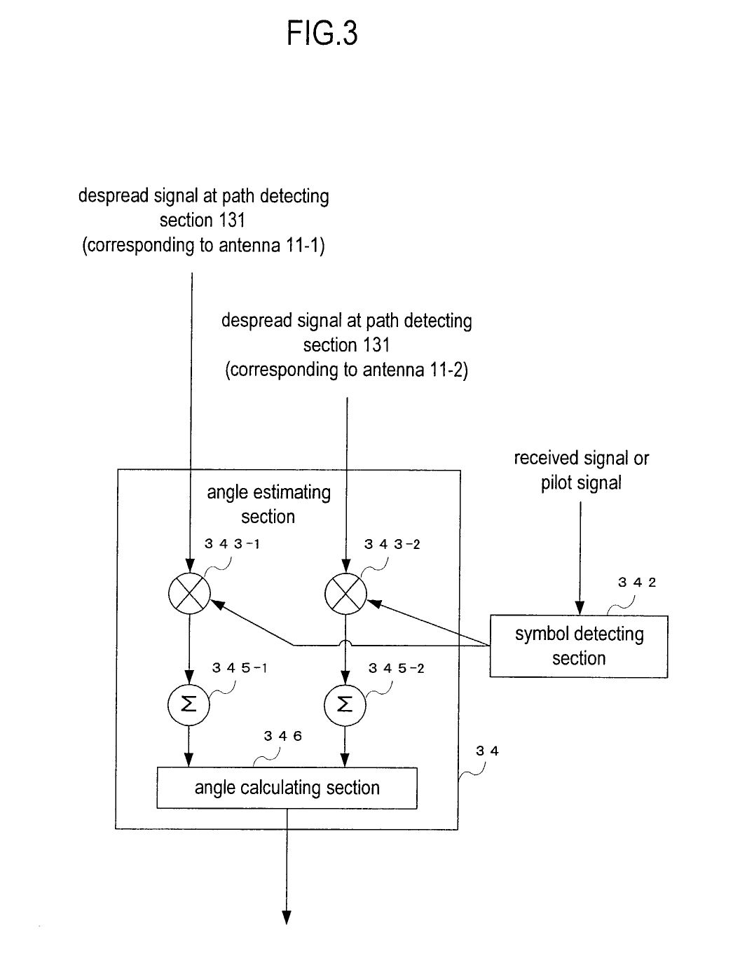

Here, an example of a structure of the angle estimating section 133 will be described referring to FIG. 3. As methods of estimating an arrival angle of a signal, direction estimating algorithms such as a MUSIC method and ESPRIT are known. On the other hand, in the present invention, a later-described estimation method based on a simple calculation is used, and the structure of FIG. 3 is an example of a structure for realizing this estimation method. FIG. 3 is a structural block diagram of an angle estimating section and a structure necessary for angle estimation in the adaptive array antenna directivity control system according to the embodiment of the present invention.

An angle estimating section 34 of FIG. 3 comprises multipliers 343-1 and 343-2, adders 345-1 and 345-2, and an angle calculating section 346. Further, a symbol detecting section 342 is provided as a structure necessary for angle estimation.

In the angle estimating section of FIG. 3, it is configured to measure arrival angles using signals received at two antennas, i.e. the antennas 11-1 and 11-2 in FIG. 1. On the other hand, it is actually configured to measure arrival angles relative to signals received at two or more antennas.

In the directivity control system of the present invention, other methods may be used as methods for estimating an arrival angle of a signal, and the angle estimating section may have other structures corresponding to estimation methods to be used.

In the angle estimating section 34 of FIG. 3, the multiplier 343 is provided for each of two or more antenna elements subjected to the angle estimation, and executes multiplication between the despread processing result included in the despread signal and a symbol value of a signal output from the symbol detecting section 342, per symbol. In FIG. 3, multiplication between the despread processing results of the signals received at the antennas 11-1 and 11-2 of FIG. 1 and the symbol value output from the symbol detecting section 342 is performed by the multipliers 343-1 and 343-2, respectively.

The adders 345 are provided correspondingly to the multipliers 343, and each adder accumulates multiplication results output from the corresponding multiplier 343 and outputs the sum to the angle calculating section 346.

In the angle estimating section 34 of FIG. 3, the multipliers 343 and the adders 345 are provided correspondingly to the first and second antennas subjected to the angle estimation.

The angle calculating section 346 estimates arrival angles of the signals at the respective paths based on the accumulation results at the respective paths output from the adders 345, and outputs the estimation result per path to the weight control section 14 as path arrival angle information.

The symbol detecting section 342 detects a symbol value based on the received signal output from the later-described adder 16, and outputs a complex conjugate value of the symbol value to the multipliers 343-1 and 343-2, respectively.

In FIG. 1, the weight control section 14 produces weights for the respective paths based on necessary information among the path detection information, the path power value information, the path arrival angle information and the selected path information, using a weight control algorithm, and outputs them to the corresponding multipliers 15-1 to 15-4, respectively. The weight producing method based on the weight control algorithm will be described later.

The multipliers 15-1 to 15-4 are provided correspondingly to the RF receivers 12-1 to 12-4, and implement multiplication between the signals received at the respective antennas and the weights of the respective paths output from the weight control section 14, and then output the multiplication results to the adder 16.

The adder 16 adds together the multiplication results from the multipliers 15-1 to 15-4, and outputs the adding result as the received signal.

Now, an operation of the directivity control system of FIG. 1 will be described referring to FIGS. 1 and 3.

In FIG. 1, signals transmitted in the up line are received at the antennas 11-1 to 11-4, and output to the RF receivers 12-1 to 12-4 corresponding to the respective antennas. The RF receivers convert the received signals from an RF band to a BB via an IF (Intermediate Frequency) band, and output them to the received data processing section 13.

The signals received at the respective antennas are input to the path detecting section 131 in the received data processing section 13. The path detecting section 131 detects arrival timings of the signals received at the respective antennas using the despread processing, thereby to detect paths of the signals.

Further, based on the signals at the respective antennas, the path detecting section 131 derives despread signals according to the detected arrival timings for the respective antenna elements, and outputs the despread signals of the necessary antenna elements to the power measuring section 132, the angle estimating section 133 and the weight control section 14 as despread signals.

When the despread signals of the respective paths are input, the power measuring section 132 measures a power value of the signal per path based on the despread signal or signals from one or more antennas, and outputs the measured power values to the path selecting section 134 and the weight control section 14 as path power value information. If the control algorithm used in the weight control section 14 does not require the path power values, the path power value information may not be output.

The angle estimating section 133 estimates an arrival angle of the signal based on the signals received at two or more antennas subjected to the angle estimation, and outputs the estimation results to the path selecting section 134 and the weight control section 14 as path arrival angle information.

Now, an operation and method of measuring the arrival angles in the angle estimating section 133 will be described in detail referring to FIG. 3.

In FIG. 3, the despread signals output from the path detecting section 131 are input to the corresponding multipliers 343 in the angle estimating section 34.

Further, the symbol detecting section 342 detects a symbol value from the received signal output from the adder 16 in FIG. 1, and outputs a complex conjugate value of the symbol value of the received signal to the multipliers 343.

The multiplier 343 performs multiplication between the despread processing result of the signal received at the corresponding antenna within the path detection information and the complex conjugate value of the symbol value of the received signal per symbol. Specifically, the multiplier 343-1 implements multiplication between the despread processing result based on the signal received at the antenna 11-1 and the complex conjugate value of the symbol value, and the multiplier 343-2 implements multiplication between the despread processing result based on the signal received at the antenna 11-2 and the complex conjugate value of the symbol value. The multiplication results of the multipliers are output to the corresponding adders 345, respectively.

The adder 345 accumulates the multiplication results output from the corresponding multiplier 343, and outputs the accumulation result to the angle calculating section 346. In FIG. 3, the adder 345-1 accumulates the multiplication results output from the multiplier 343-1 over a plurality of symbols, and the adder 345-2 accumulates the multiplication results output from the multiplier 343-2 over a plurality of symbols.

Based on the accumulation results output from the adders 345, the angle calculating section 346 estimates arrival angles from a phase difference between the signals at the two antennas subject to the angle estimation, and outputs the estimation results representing arrival angles of the respective paths, to the path selecting section 134 and the weight control section 14 as path arrival angle information. In FIG. 3, the angle calculating section 346 estimates the arrival angle using the signal received at the antenna 11-1.

Now, the angle estimation method in the angle calculating section 346 will be described. Assuming that a despreading calculation result of a signal received at an i-th antenna is Zᵢ(k), and a symbol value detected in the symbol detecting section 342 is S(k), wherein k represents a symbol number, an accumulation result in an adder 345-i corresponding to the i-th antenna is given by an equation (1).

$${L}_{i} = {\sum }_{k = 1}^{K} {Z}_{i} ( k ) S * ( k ) \qquad ( 1 )$$

In the equation (1), Li represents a mean phase of a signal, and S* represents a complex conjugate value of a symbol value.

The angle calculating section 346 estimates an arrival angle based on the accumulation results about two antennas subjected to the arrival angle estimation, among the accumulation results given by the equation (1). Assuming that the accumulation results based on the signals received at the i-th and (i+1)-th antennas are used as arrival angle estimation objects, a phase difference Δφ between the signals at both antennas is given by an equation (2).

Δφ=arg(Lᵢ₊₁/Li) (2)

Further, assuming that an antenna element interval is d, a path difference between the signals received at the i-th and (i+1)-th antennas is Δl, and a wavelength relative to a carrier frequency is λ, the phase difference Δφ is also given by an equation (3).

Δφ=2πΔl/λ=2πd sin θ/k (3)

From the equation (3), an arrival angle θ of the signal received at the antenna can be calculated by an equation (4).

$$θ = {sin}^{- 1} ( \frac{Δφλ}{2 π d} ) \qquad ( 4 )$$

The angle calculation section 346 estimates an arrival angle of the signal of each antenna by executing the calculations of the equations (2) to (4), and determines them as the arrival angles of the respective paths. Preferably, the angle calculating section 346 is configured to store parameters necessary for the foregoing equations.

Other methods may be used as methods for estimating an arrival angle of a signal, and the structure for implementing the angle estimation may also have other structures corresponding to estimation methods to be used.

Instead of the path arrival angle information being the arrival angle estimation result, the angle estimating section 133 may calculate information corresponding to estimated angles and output it to the path selecting section 134 and the weight control section 14. The directivity control system of FIG. 1 can use an array response vector being a vector representing phase differences of the received signals at the respective antennas, as the information corresponding to the estimated angles.

The array response vector is a vector composed of elements corresponding to the number of the antennas and represented by phase differences of the signals arrived at the respective antennas, and can be derived from the path arrival angle information of the respective antennas in the angle estimating section 34.

The angle estimating section 133 calculates, in the angle calculating section, phase differences of the signals arriving at the respective antennas according to the foregoing angle estimation method. If the antennas are arranged at regular intervals, by calculating a phase difference between the signals arriving at the phase reference antenna and arriving at the antenna adjacent thereto, the angle estimating section 133 can derive phase differences relative to the other antennas.

Then, the angle estimating section 133 derives, in the angle calculating section, an array response vector using the phase differences of the signals arriving at the respective antennas. Assuming that the directivity control system of FIG. 1 is provided with four antennas arranged at regular intervals, and a phase difference between the signals at the respective antennas is Δφ, an array response vector of each antenna can be expressed by [1, exp(j*Δφ), exp(j*2Δφ), exp(j*3Δφ)]. Here, such an antenna having the array response vector of 1 is an antenna that becomes a reference of a phase difference.

As described above, the array response vector is a relative value that can be represented by phase differences between the respective antennas. If the antennas are arranged at regular intervals, the angle estimating section 133 can derive array response vectors relative to all the antennas only by calculating a phase difference between the phase reference antenna and the adjacent antenna, so that the calculation amount in the angle estimating section 133 can be reduced.

It is known that the accuracy of the estimated arrival angle depends on the arrival angle of the signal. When the weight control section 14 executes the weight control to the received signal based on the path arrival angle information, if an error of the estimated angle is large, a serious influence is reflected on the control. By using the array response vector, the weight control section 14 can implement the accurate weight control irrespective of the arrival angle of the signal.

In FIG. 1, the path selecting section 134 forms a characteristic part of the present invention. The path selecting section 134 selects a wishing path from the detected paths based on at least one of the input path power value information and path arrival angle information, and outputs the selection result to the weight control section 14 as selected path information. This can realize the antenna control that reduces the interference in the up line.

An example of the wishing path selection method in the path selecting section 134 will be described later.

In FIG. 1, the weight control section 14 produces weights ù1 to ù4 for the respective paths based on necessary information among the path detection information, the path power value information, the path arrival angle information and the selected path information output from the received data processing section 13, and outputs them to the multipliers 15-1 to 15-4 corresponding to the respective antennas, respectively. The weight control section 14 produces the weights of the respective paths according to the weight control algorithm.

The multipliers 15-1 to 15-4 implement multiplication between the signals received at the respective antennas and the weights of the respective paths produced by the weight control section 14, respectively, and outputs the multiplication results to the adder 16.

In FIG. 1, the multipliers 15-1 to 15-4 implement multiplication between the signals received at the respective antennas and the weights ù1 to ù4 of the respective paths output from the weight control section 14, respectively, and outputs the multiplication results to the adder 16.

The adder 16 derives the sum of the multiplication results output from the multipliers 15-1 to 15-4, and outputs the sum as a received signal. The received signal is output to the symbol detecting section 342 in FIG. 3 as a demodulating signal or a pilot signal known in the base station, so that the symbol detection is implemented, while it is output to a demodulating section (not shown) or the like so that demodulation processing is implemented.

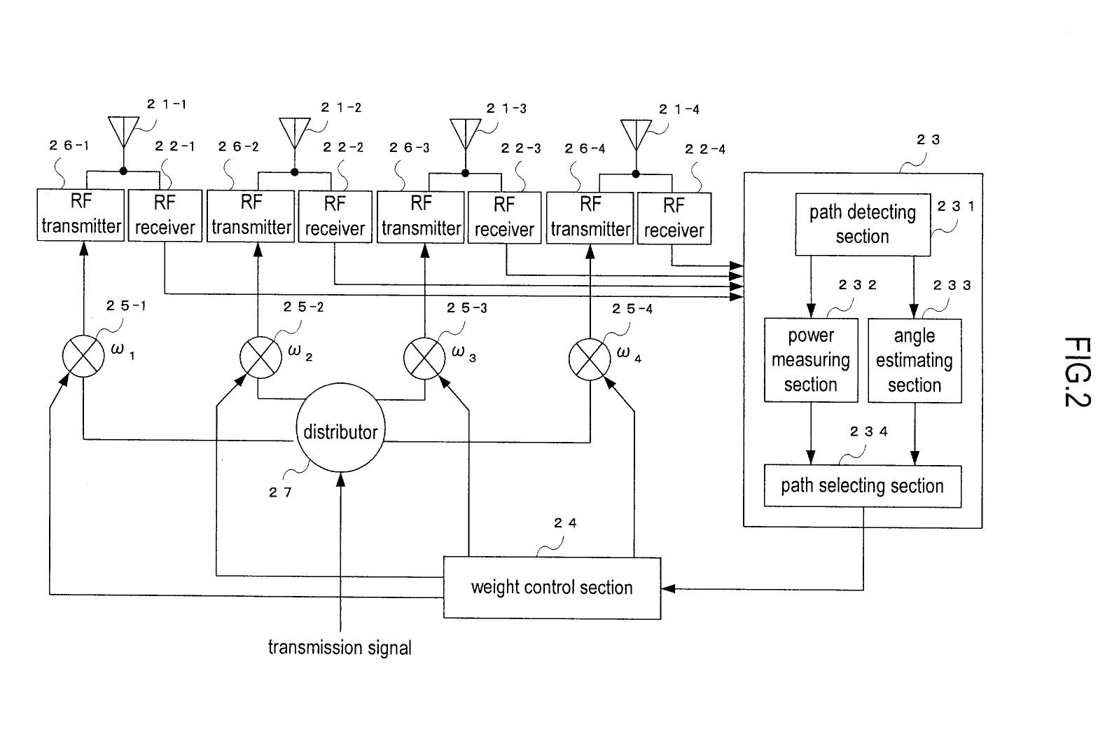

Now, a structure of another adaptive array antenna directivity control system according to an embodiment of the present invention will be described referring to FIG. 2. FIG. 2 is a structural block diagram of the adaptive array antenna directivity control system corresponding to a down line, according to the embodiment of the present invention.

In a CDMA base station, the adaptive array antenna directivity control system of FIG. 2 (hereinafter referred to as “directivity control system of FIG. 2”) measures power values and arrival angles of signals of the respective paths received at a plurality of antennas and selects a wishing path based on the measurement results, while executes a weight control to signals to be transmitted from the respective antennas based on the measurement results and radio-outputs them as transmission signals. The directivity control system of FIG. 2 comprises four antennas and performs the path selection and the weight control based on the signals received at the respective antennas. However, the number of the antennas may have another value.

The directivity control system of FIG. 2 comprises antennas 21-1 to 21-4, RF receivers 22-1 to 22-4, a received data processing section 23, a weight control section 24, multipliers 25-1 to 25-4, RF transmitters 26-1 to 26-4 and a distributor 27. Further, the received data processing section 23 comprises a path detecting section 231, a power measuring section 232, an angle estimating section 233 and a path selecting section 234.

Now, the respective elements of the directivity control system of FIG. 2 will be described. Because the antennas 21-1 to 21-4, the RF receivers 22-1 to 22-4 and the received data processing section 23 in FIG. 2 have the same structures that those of the corresponding elements in FIG. 1, explanation thereof is omitted.

The weight control section 24 produces weights for the respective paths based on necessary information among the path detection information, the path power value information, the path arrival angle information and the selected path information using the weight control algorithm, and outputs them to the corresponding multipliers 25-1 to 25-4, respectively.

The distributor 27 distributes spread-modulated transmission signals to the respective multipliers 25-1 to 25-4.

The multipliers 25-1 to 25-4 are provided for the respective RF transmitters 26-1 to 26-4, and implement multiplication between the transmission signals output from the distributor 27 and the weights of the respective paths output from the weight control section 24, and output the multiplication results to the RF transmitters 26-1 to 26-4.

The RF transmitters 26-1 to 26-4 are provided for the respective antennas 21-1 to 21-4, and frequency-convert the multiplication results output from the corresponding multipliers 25-1 to 25-4, from a BB band to an RF band, and output them to the antennas 21-1 to 21-4. The transmission signals output to the antennas 21-1 to 21-4 are ratio-transmitted to communication destination mobile stations.

Now, an operation of the directivity control system of FIG. 2 will be described referring to FIG. 2.

In FIG. 2, an operation from the reception of signals at the antenna 21-1 to 21-4 to the selection of a wishing path in the received data processing section 23 is the same as that in the directivity control system of FIG. 1, so that explanation thereof is omitted.

In FIG. 2, the weight control section 24 produces weights ù1 to ù4 for the respective paths based on necessary information among the path detection information, the path power value information, the path arrival angle information and the selected path information, and outputs them to the multipliers 25-1 to 25-4 corresponding to the respective antennas, respectively. The weight control section 24 produces the weights of the respective paths according to the weight control algorithm.

On the other hand, the BB transmission signals to be transmitted to the respective mobile stations are spread-modulated in a radio modulating section (not shown) and output to the distributor 27. The distributor 27 distributes and outputs the transmission signals to the multipliers 25-1 to 25-4, respectively.

The multipliers 25-1 to 25-4 implement multiplication between the transmission signals output from the distributor 27 and the weights ù1 to ù4 of the respective paths output from the weight control section 14, and output the multiplication results to the RF transmitters 26-1 to 26-4.

The RF transmitters 26-1 to 26-4 frequency-convert the multiplication results output from the corresponding multipliers 25-1 to 25-4 to the RF band and output them to the antennas 21-1 to 21-4. The transmission signals output to the antennas 21-1 to 21-4 are radio-transmitted to communication destination mobile stations. Accordingly, a wishing path selected in the directivity control system of FIG. 2 is a wishing path for transmission.

In the directivity control system of FIG. 1, the weight control section 14 produces the reception weights based on the signals received at the antennas, and the weight control is executed relative to the received signals in the multipliers 15. On the other hand, in the directivity control system of FIG. 2, the weight control section 24 produces the transmission weights based on the signals received at the antennas, and the weight control is executed relative to the transmission signals in the multipliers 25.

In the directivity control system of FIG. 2, the weight control relative to the received signals may also be executed independently of the weight control relative to the transmission signals.

In the directivity control system of FIG. 2, similarly to FIG. 1, the angle estimating section 233 may derive an array response vector instead of the path arrival angle information, and output it to the path selecting section 234 and the weight control section 24. The calculation processing of the array response vector in the angle estimating section 233 is performed in the angle calculating section, similarly to FIG. 1.

In the radio communication system, there is a communication type like FDD (Frequency Division Duplex) wherein radio communication is carried out using frequencies that differ between the up line and the down line. As expressed by the foregoing equation (3) in the explanation of FIG. 1, the phase difference between the signals at the respective antennas is determined by the communication frequencies, which is also applicable to the array response vector. Therefore, in such a communication type, it is necessary to derive array response vectors separately for the up line and the down line.

In the directivity control system of the present invention, if the antenna directivity is controlled in both up and down lines, the array response vector for the down line can be calculated using the arrival angles of the signals or the array response vector derived for the up line. This calculation method will be explained hereinbelow.

Assuming that, with respect to a certain antenna, a distance from a phase reference antenna is d, an arrival angle of a signal relative to such an antenna is θ, and the frequency of the signal is λ, a phase difference Δφ between the phase reference antenna and the antenna concerned is given by Δφ=2·*sin θ/λd.

Because the arrival angle is identical in the up and down lines, if the arrival angle θ in the up line is known from the foregoing equation, the array response vector in the down line can be derived using the arrival angle θ.

Further, in the directivity control system of the present invention, the array response vector in the down line can also be derived using the array response vector in the up line.

Assuming that, with respect to a certain antenna, a distance from a phase reference antenna is d, an arrival angle of a signal relative to such an antenna is θ, a phase difference and frequency in the up line are Δφu and λu, respectively, and a phase difference and frequency in the down line are Δφd and λd, respectively, a relationship of 2·*sin θ/λu=Δφu and 2·*sin θ/λd=Δφd is established from the foregoing equation (3).

Accordingly, the phase difference Δφd in the down line can be expressed by Δφd=Δφu*λu/λd, so that the array response vector in the down line can be derived.

According to the foregoing method of calculating the array response vector of the down line, because the array response vector in the down line can be derived using the arrival angles or the array response vector in the up line, the calculation amount of the angle estimating section 233 can be reduced as compared with deriving the array response vector per line.

Now, the wishing path selection methods implemented in the path selecting sections of the directivity control systems of FIGS. 1 and 2 will be described.

In the CDMA communication, for enhancing an interference removing effect and preventing reduction of a gain in a direction of a wishing path, it is important to select, as a wishing path, such a path that has no large interference waves in the neighborhood thereof and that does not have interference waves on both sides thereof.

In the down line of CDMA, signals of mobile stations are mutually synchronized, with spreading codes being orthogonal to each other. Thus, if there is only one path connecting between a base station and a mobile station, even when a high-power signal of another mobile station is included in the path, no interference is caused on the side of the mobile station.

However, if a high-power signal exists in a multi-path direction, i.e. if there exists a mobile station having a wishing path in the neighborhood of the multi-path direction, interference is generated. Therefore, if there is a mobile station locating nearby in angle, it is effective to bring a transmission path being a wishing path close thereto.

Signals of other mobile stations become interference signals in the up line, while multi-paths become interference signals in the down line. Accordingly, in the embodiment of the present invention, the path selecting section considers a difference of the lines so as to select such a wishing path that can remove the interference caused by those signals.

The path selection using angles is effective for high-speed communication users. Although the path selecting section performs the path selection for covering all the users, it may also be arranged that the path selection method using angles only covers the high-speed communication users, and the path selection using power value information is implemented for covering other users such as low-speed communication users. The communication speed of the path can be known from a spreading code used in the path detecting section.

In general, the adaptive array antenna reduces a directional gain relative to 1) an interference path that is distanced in angle to a certain degree, 2) a high-power interference path, and 3) a direction in which interference paths are gathered together.

To judge an optimum path based on the arrival angles and power values, being the feature of the path selection method in the directivity control system of the present invention, is nothing but to make the most of the foregoing directional pattern characteristic of the adaptive array antenna. However, because the reception characteristics are subjected to complicate changes due to differences in arrival angle or power value of interference paths, particularly fluctuation thereof caused by fading, it is difficult to make an optimum path selection model. For accomplishing the path selection, however, it is necessary to make a path selection standard from such path location states and reception characteristics that exhibit complicate changes.

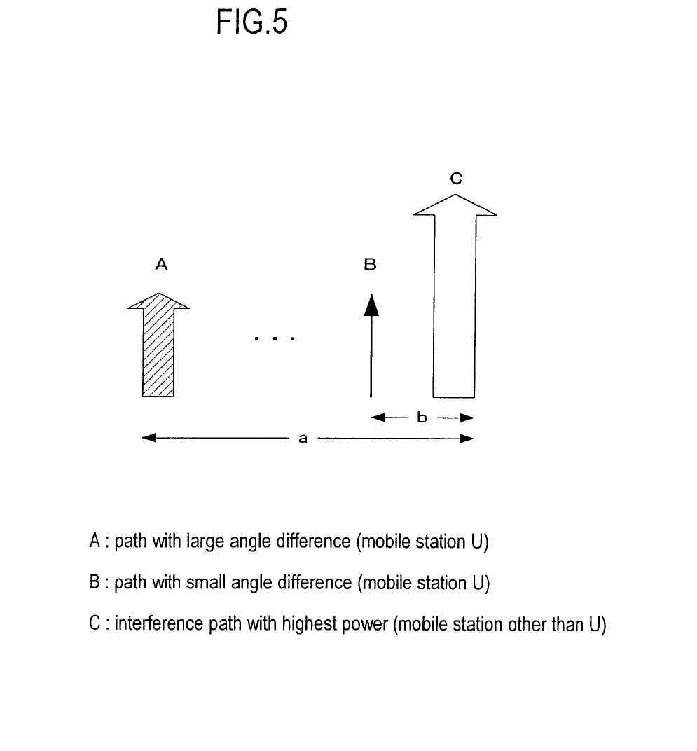

Hereinbelow, an example of the path selection method in the path selecting section will be described per direction of the line with reference to FIGS. 5 to 7. In FIGS. 5 to 7, a length of each arrow represents the magnitude of a power value, while a distance between arrows represents the magnitude of an angle.

FIG. 5 is a diagram showing a wishing path selection method implemented in the directivity control system in the up line. It is asynchronous in the up line, all the paths except a wishing path, arriving at a radio communication device, can be interference paths.

In FIG. 5, the respective arrows represent paths detected in the directivity control system of FIG. 1, wherein A and B represent paths of the same mobile station U, and C represents an interference path having the greatest power value. The interference path C is a path of a mobile station other than the mobile station U of the paths A and B. As described above, if a high-power interference path exists nearby, the interference is caused. Accordingly, in the directivity control system of FIG. 1, the path A having the greatest angle difference from the interference path C is selected as a wishing path.

The path selection method of FIG. 5 is effective when there are a plurality of mobile stations performing the high-speed communication with the base station in the up line, or when the communication is performed using a plurality of paths. In FIG. 5, it is acceptable that a path of the mobile station U exists between the paths A and B, or a plurality of paths of mobile stations other than the mobile station U exist in addition to the path C.

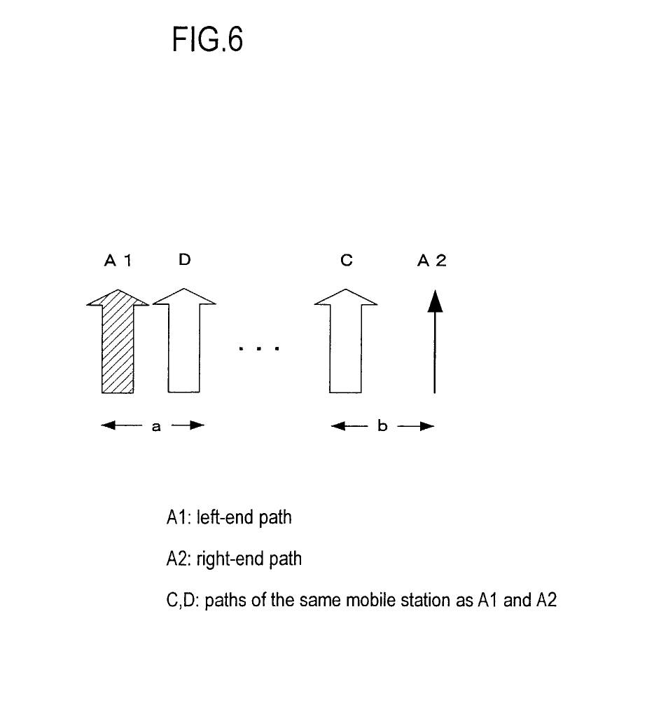

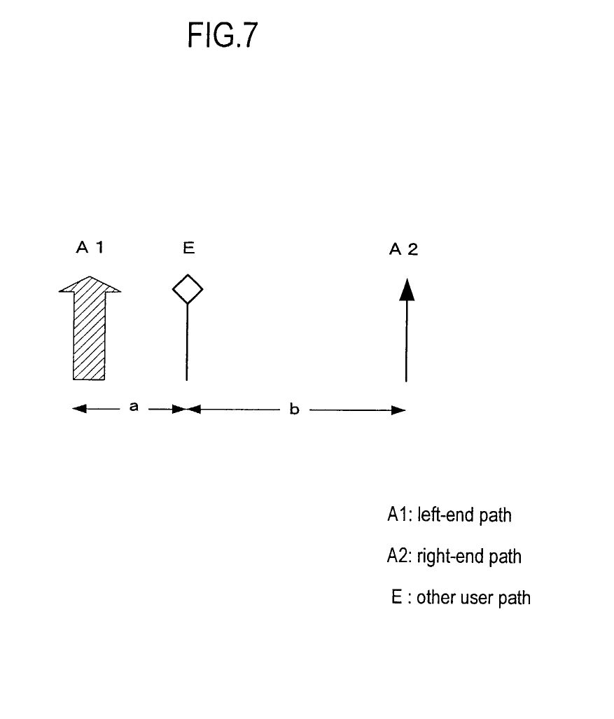

FIGS. 6 and 7 are diagrams showing wishing path selection methods implemented in the directivity control system in the down line.

As described above, in the CDMA down line, spreading codes corresponding to the respective mobile stations are orthogonal and synchronized with each other. Therefore, in the down line, multi-paths of the subject mobile station become interference signals. If there exist a plurality of paths due to multi-paths, it becomes asynchronous between the paths, which causes interference.

Accordingly, in the adaptive array antenna, it is necessary to reduce the interference due to multi-paths by lowering antenna gains in multi-path directions. However, there has been a problem that, when the multi-paths exist in angle directions in the neighborhood of a transmission path direction, it is difficult to lower the antenna gains of the multi-paths and, when the multi-paths exist on both sides of the transmission path, an antenna gain of the transmission path is lowered, thereby to increase the interference.

In the path selection method of FIG. 6, if there is only one mobile station, path selection is carried out such that, from paths A1 and A2 located at both ends among paths subjected to selection, a path that is most remote from its adjacent path C or D is selected as a wishing path, i.e. a transmission path. For example, assuming that an angle difference between paths A1 and D is a, and an angle difference between paths A2 and C is b, the path A1 is selected when a>b, while the path A2 is selected when a<b. Because the base station uses the directional antenna, the ends are defined in the limited range. In case of non-directional, however, the ends are defined in an angle width approximate to a user existing range.

In FIG. 6, if the path C or D is selected as a transmission path, interference is caused on both right and left sides of the path. On the other hand, if the path A1 or A2 is selected, only the right or left side of the path is subjected to the multi-path interference. Further, by selecting one that is most remote from the multi-paths, lowering of the multi-path gains can be facilitated.

The path selection method of FIG. 6 is effective when one mobile station implements high-speed communication using a plurality of paths in the down line, and the paths are approximate in angle to each other. In FIG. 6, a plurality of paths may be located between the paths C and D, or the paths C and D may represent the same path.

In FIG. 7, A1 and A2 represent paths located at ends of an angle range for implementing path selection based on angles, E represents a path located within such an angle range, and the path E is a path of a mobile station other than a mobile station of the paths A1 and A2. An angle difference between the paths A1 and E is a, and an angle difference between the paths A2 and E is b, wherein a<b.

Assuming that, from paths located at ends among high-power interference sources, the path having a small angle difference from an adjacent path is selected as a transmission path, and such an adjacent path is a path of a different mobile station, because an interference reduction effect relative to the adjacent path is small, the signal of the high-power mobile station is included in the adjacent path, which thus becomes an interference signal.

Here, if the adjacent path is selected as a transmission path, because the signals of the mobile station having the adjacent path and the mobile station having the end path are synchronized, no interference is caused. On the other hand, if the end path and its adjacent path are selected as transmission paths, for example, if the paths A1 and E are selected as transmission paths, the antenna directivity of the paths A1 and E reduces gains in an interference direction toward the right end direction. Thus, interference influenced on the path A2 is reduced. However, if the paths A2 and E are selected as transmission paths, because an angle difference between the paths A1 and E is small, the directional pattern of the path E has a large gain also in the direction of the path A1, so that the path A2 is subjected to an influence of interference by the path A1. Therefore, by selecting the paths A1 and E as transmission paths, reduction of the antenna gains of the transmission paths themselves can be avoided, thereby to improve the interference reduction effect of the antenna.

The path selection method of FIG. 7 is effective when a plurality of mobile stations perform high-speed communication in the down line, and the paths of the mobile stations are approximate to each other. The path selection method of FIG. 7 is also applicable to the case wherein the paths A1 and A2 do not belong to the same mobile station, i.e. the path E is multi-paths.

In the path selection method of FIG. 7, a plurality of paths of other mobile stations may be located in the angle range. In this case, a path that has the smallest angle difference relative to the right or left end path, and that right or left end path are selected as transmission paths.

When performing communication with mobile stations of a plurality of users, the path selecting section first selects wishing paths for two users in a manner to suppress interference applied to the selected paths, and thereafter, the path selecting section selects another wishing path and then repeats selection of a new wishing path from paths of another user in the same manner.

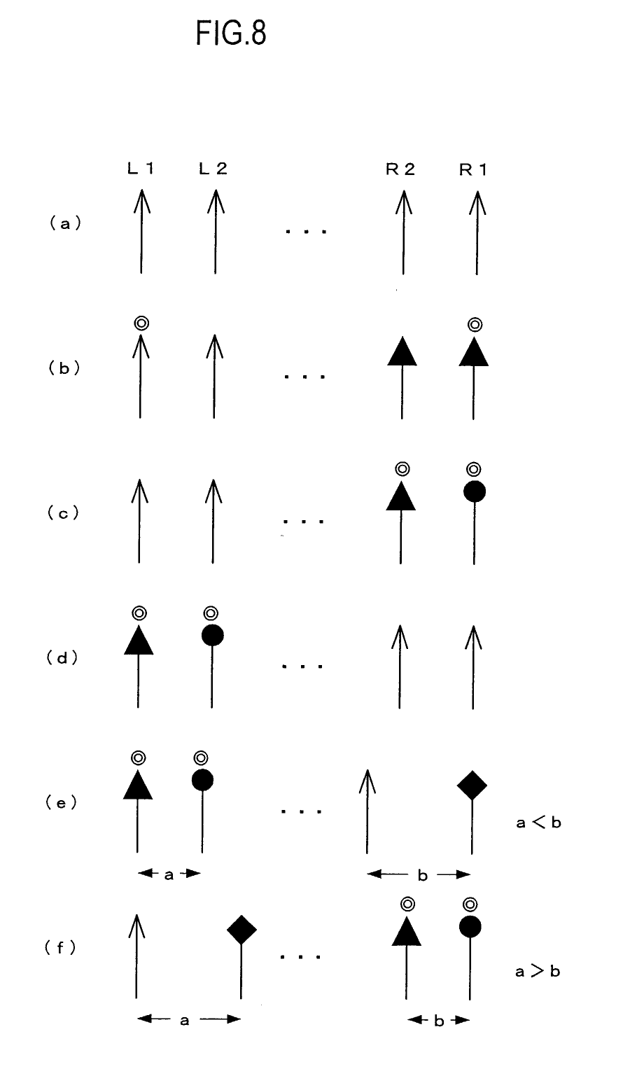

Wishing path selection methods obtained by classifying the path selection method of FIG. 7, which are applicable to the case of two or more users, will be described with reference to FIG. 8. FIG. 8 is a diagram showing methods of selecting wishing paths for the first two users in the directivity control system of the present invention.

Among extracted high-speed communication paths, attention is paid to two paths at each of both sides, i.e. four paths in total. As shown in FIG. 8(a), left-end two paths are identified as L1 and L2, and right-end two paths are identified as R1 and R2. In FIG. 8, a distance between paths represents an angle difference for simplifying explanation. If the adjacent two arrows are of the same kind, it represents paths of the same mobile station, while, if otherwise, it represents paths of different mobile stations.

The path selecting section selects wishing paths by confirming whether L1 and L2 are paths of the same mobile station, and R1 and R2 are paths of the same mobile station, and by recognizing an angle difference between the paths. Hereinbelow, explanation will be given by grouping the cases.

When L1 and L2 are paths of the same mobile station, and R1 and R2 are also paths of the same mobile station, while L1 and R1 are not paths of the same mobile station (FIG. 8(b)), the path selecting section selects L1 and R1 as wishing paths.

When L1 and L2 are paths of the same mobile station, while R1 and R2 are not paths of the same mobile station (FIG. 8(c)), the path selecting section selects R1 and R2 as wishing paths.

When L1 and L2 are not paths of the same mobile station, while R1 and R2 are paths of the same mobile station (FIG. 8(d)), the path selecting section selects L1 and L2 as wishing paths.

When L1 and L2 are not paths of the same mobile station, and R1 and R2 are not paths of the same mobile station, while an angle difference a between L1 and L2 is smaller than an angle difference b between R1 and R2 (FIG. 8(e)), the path selecting section selects L1 and L2 as wishing paths.

When L1 and L2 are not paths of the same mobile station, and R1 and R2 are not paths of the same mobile station, while an angle difference a between L1 and L2 is greater than an angle difference b between R1 and R2 (FIG. 8(f)), the path selecting section selects R1 and R2 as wishing paths.

The path selecting section first selects wishing paths for two mobile stations according to the five patterns of FIGS. 8(b) to (f). When there are three or more mobile stations, a path that is remote from multi-paths of the mobile stations having the selected wishing paths is selected as a wishing path.

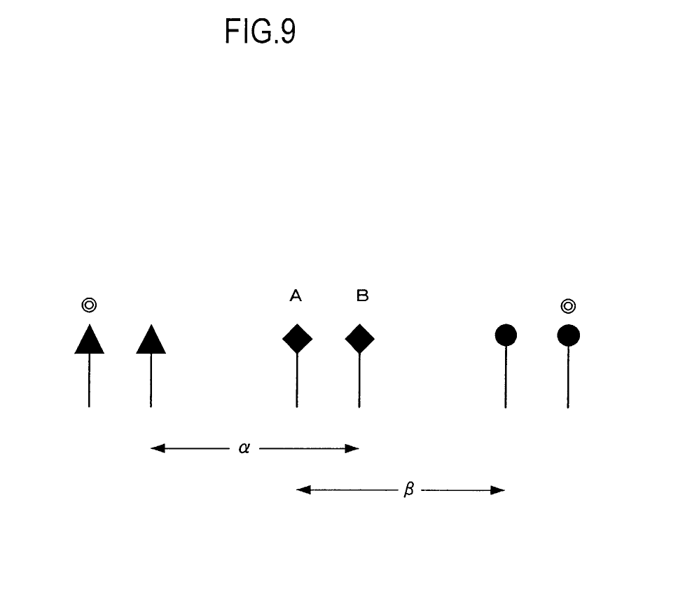

A wishing path selection method in case of three mobile stations will be described referring to FIG. 9. FIG. 9 is a diagram showing a method of selecting wishing paths when there are three mobile stations. Symbols and indication in the figure are the same as those in FIG. 8.

In FIG. 9, it is assumed that L1 and R1 have already been selected as wishing paths according to the pattern of FIG. 8(b). Because L1 and L2 are paths of the same mobile station, and R1 and R2 are paths of the same mobile station, L2 and R2 become multi-paths.

In this event, if paths A and B of another mobile station are detected, assuming that an angle difference between B and L2 is a, and an angle difference between A and R2 is β, the path selecting section selects B as a wishing path when α<β, while selects A as a wishing path when α>β.

Thereafter, the path selecting section performs selection of a wishing path from paths of the remaining mobile stations according to the selection method shown in FIG. 9.

According to the foregoing wishing path selection methods, the directivity control system of the present invention can reduce interference averagely relative to a plurality of mobile stations.

When a wishing path selection pattern does not match with those of FIGS. 8(b) to (f), the path selecting section selects a path having the greatest power value among the detected paths as a wishing path. When there are paths of the same power level, the leading wave is selected.

In the foregoing path selection method, even if a path is optimum in view of an arrival angle, when the power value is small, i.e. the propagation path attenuation is large, it is possible that the power value of an interference signal increases, or even if a path is optimum in view of a power value, it is possible that an interference signal having an approximately equal power value exists in the neighborhood thereof. It can not be said to be an optimum path in either case.

In view of this, the path selecting section implements the foregoing path selection method based on arrival angles and the conventional method of selecting a path having the greatest power value, in parallel to each other. When a power difference between a path selected by the path selecting method based on arrival angles and a path having the greatest power value is no less than a predetermined value, the path selecting section selects the path having the greatest power value as a wishing path. On the other hand, if it is less than the predetermined value, the path selecting section selects the path selected by the path selection method based on arrival angles as a wishing path and, if there is no such a path, the path selecting section selects the path having the greatest power value as a wishing path.

The inventor conducted a simulation of the path selection according to the two methods in a communication environment of high-speed two users with three paths, using the directivity control system of the present invention, and confirmed that the transmission characteristics were improved by setting as a wishing path a path selected based on an arrival angle when the path selected based on the arrival angle was attenuated by 4 dB as compared with a path having the greatest power value, and by setting as a wishing path the path having the greatest power value when the path selected based on the arrival angle was attenuated by 5 dB or more.

According to the foregoing wishing path selection method, the directivity control system of the present invention can improve the interference removing effect and maintain the gain in the direction of the wishing path.

The inventor conducted a simulation using the directivity control system of FIG. 2 for examining the interference removing effect according to the foregoing path selection.

Upon conducting the simulation, it was assumed that there existed only four-times spread high-speed communication mobile stations as mobile stations for communication. It was further assumed that the number of mobile stations and paths was two users with three paths, the paths had the same power level, the mobile stations were uniformly distributed in a 120-degree sector, and delayed waves were uniformly distributed within ±5 degrees of the leading wave.

Further, as conditions of the antenna, it was assumed that six antenna elements were linearly arrayed at half-wavelength intervals, the transmission power that caused the SN ratio before despreading in the 120-degree sector antenna front direction to be 0 dB was defined as a reference value 0 dB, and the upper limit of the transmission power was set to 35 dB.

In the foregoing environment, the simulation of interference removal based on the foregoing path selection was performed by changing the arrangement of the mobile stations 4000 times and using the following weight control algorithm as a beam control method.

Here, explanation will be made of an example of the weight control algorithm in the weight control section 24 used in the simulation. Although various methods were known for the weight control, the weight control method using estimated angles was implemented herein.

The weight control section 24 in this example calculates an array response vector per path based on an arrival angle of each path estimated in the received data processing section and the frequency of the line. Then, the weight control section 24 calculates a weight of each path based on the determined array response vector of each path and a power value of a signal of each path.

As a concrete calculation method, the weight control section 24 first derives a correlation matrix Rxx of a weight. A calculation equation is given by an equation (5).

Rxx=ΣPᵢVᵢ*Vᵢ^{T}+PₙI (5)

In the equation (5), Vᵢ represents an array response vector of a signal received at an i-th antenna, Pᵢ represents a value assumed to be a power value in the i-th antenna, Pₙ represents a thermal noise power, “T” represents transposition, and I represents a unit matrix.

Then, the weight control section 24 calculates a weight of each path using the correlation matrix derived by the equation (5). A weight Wₖ relative to a signal received at a k-th antenna is given by an equation (6).

Wₖ=Rxx⁻¹Vₖ* (6)

The weight control section 24 calculates a weight relative to each antenna using the equation (6), and outputs it to the multiplier corresponding to each antenna.

In the foregoing weight calculation method, the correlation matrix is calculated based on the array response vector of each path and the assumed power (Pᵢ/Pₙ). As the assumed power increases, the directivity in a direction of a delayed path located very close to a wishing path can be lowered. In the simulation, the assumed power was set to 30 dB. In the equation (5), the Σ part represents addition of only the high-speed user paths, not addition of all the user paths, so that the interference in high-speed communication with the mobile stations is reduced.

By this control, the array vectors can be determined and the weights can be calculated such that the antenna gain in the wishing path direction is improved while the antenna gain in the interference path direction is reduced.

The weight control algorithm used in the weight control section 24 may be replaced with another algorithm. In general, the LMS (Least Mean Square) algorithm is used in the up line. Details of the LMS are described in L. C. Godara, “Application of Antenna Arrays to Mobile Communications, Part 2: Beam-Forming and Direction-of-Arrival Considerations”, Proc. IEEE, vol 85, no.8, pp.1195-1245, August 1997.

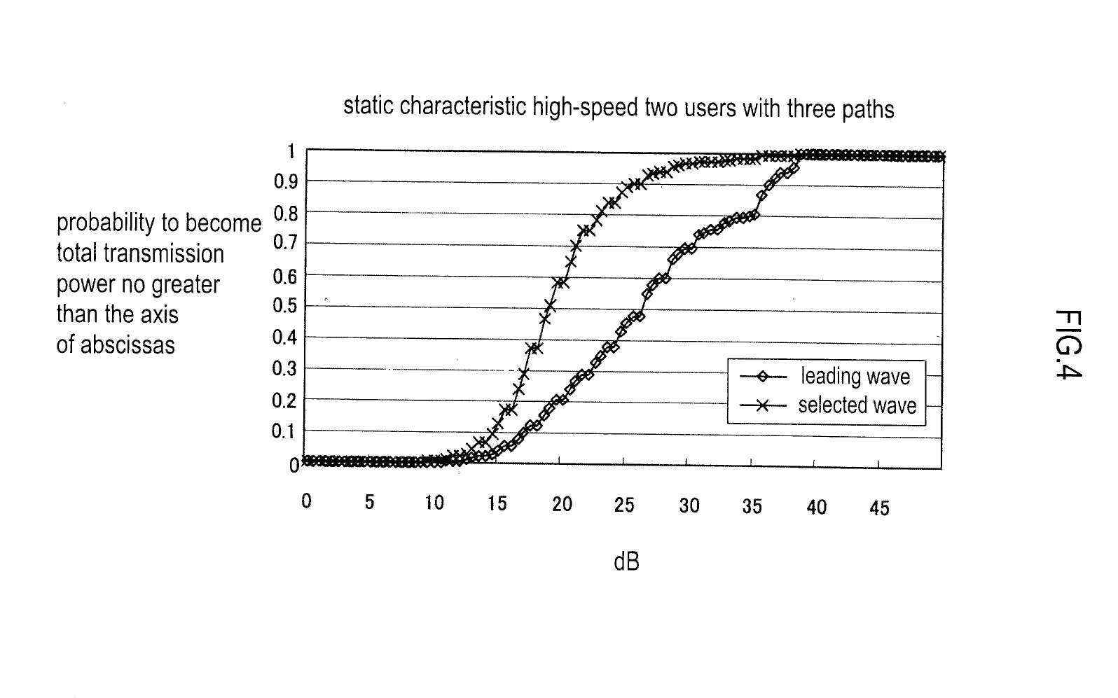

The results of the interference removal in the foregoing simulation are as shown in FIG. 4. FIG. 4 is a cumulative frequency distribution diagram of the total transmission power values according to the prior art and the directivity control system of FIG. 2.

Here, the total transmission power represents the sum of the powers transmitted from the base station to the respective mobile stations. It is known that as the total transmission power decreases, the total interference over the area, also including other cells, is reduced. In FIG. 4, the axis of abscissas represents the total transmission power value (unit: dB), and the axis of ordinates represents the probability to become the corresponding total transmission power value.

In the cumulative frequency distribution diagram of FIG. 4, it is shown that as approaching leftward, many mobile stations can be accommodated with a small transmission power value. It is clear that the probability is higher to accomplish the transmission with smaller transmission power values in case of the selected waves (x marks) according to the path selection in the present invention as compared with the conventional leading waves (rhombic marks), so that more mobile stations can be accommodated.

Further, the rate of the mobile stations that do not satisfy the SN ratio, i.e. the rate of the mobile stations wherein the total transmission power exceeds the upper limit (35 dB) of the transmission power, is 11.7% in case of the leading waves and 0.98% in the path selection of the present invention. This exhibits improvement of the interference removing effect according to the directivity control system of the present invention.

According to the directivity control system of FIG. 1, the paths are detected from the signals received at the respective antennas, the wishing path is selected based on at least one of the power values and the arrival angles of the detected paths, the weights are produced based on the path selection result, the signals are multiplied by the weights and the sum of the multiplication results is derived to be the received signal, so that the optimum wishing path can be selected in the up line, thereby to improve the interference removing effect as compared with the prior art.

Particularly, by selecting the wishing path based on at least one of the power values and the arrival angles of the paths, the wishing path that is most free of an influence of interference coping with various interference conditions can be selected, so that the interference removing effect can be improved and the reception characteristics in the up line can be improved.

There is a case wherein the base station deals with low-speed communication mobile stations as communication objects. In general, the spreading rate of the low-speed transmission terminal is high, so that, even if deterioration in characteristic due to multi-path interference occurs, improvement in communication characteristic can be expected by performing the RAKE synthesis. Specifically, in case of the low-speed communication, the characteristic is not deteriorated so much even if an interference signal exists nearby.

Therefore, in the path selecting section, by limiting the foregoing path selection based on the arrival angles to the mobile stations performing the high-speed data transmission that require improvement in interference removing effect, and by selecting the path having the greatest power value as the wishing path with respect to the mobile stations performing the low-speed communication, the processing time and load required for the path selection of the low-speed mobile stations can be reduced, thereby to improve the communication characteristics of the antenna.

Therefore, in the directivity control system of FIG. 1, by limiting the foregoing wishing path selection methods to the mobile stations that implement the high-speed data communication, and by selecting the path having the greatest power value as the wishing path with respect to the low-speed communication mobile stations, there is an effect of reducing the processing time and load required for the path selection of the low-speed communication mobile stations.

In the foregoing wishing path selection method, by arranging that if a power difference between a path selected by the path selecting method based on arrival angles and a path having the greatest power value is no less than a predetermined value, the path having the greatest power value is selected as a wishing path, while, if it is less than the predetermined value, the path selected by the path selection method based on arrival angles is selected as a wishing path and, if there is no such a path, the path having the greatest power value is selected as a wishing path, there is an effect of improving the interference removing effect and maintaining the gain in the wishing path direction.

According to the directivity control system of FIG. 2, the paths are detected from the signals received at the respective antennas, the wishing path is selected based on at least one of the power values and the arrival angles of the detected paths, the weights are produced based on the path selection result, and the signals to be transmitted from the antennas are multiplied by the corresponding weights so as to be output from the antennas as the transmission signals, so that the optimum wishing path can be selected in the down line, the transmission power of the transmission signals can be reduced, and the transmission power to other mobile stations that perform communication can also be reduced. Therefore, there is an effect of increasing the accommodation number of users in the base station. Further, there is an effect of improving the interference removing effect and improving the transmission characteristics in the down line.

Particularly, in the down line, only the multi-paths of the wishing path become interference signals. Accordingly, as compared with the up line wherein all the signals from other mobile stations become interference signals, the effect based on the path selection is significant.

Further, in the directivity control system of FIG. 2, by limiting the foregoing wishing path selection methods to the mobile stations that implement the high-speed data communication, and by selecting the path having the greatest power value as the wishing path with respect to the low-speed communication mobile stations, there is an effect of reducing the processing time and load required for the path selection of the low-speed communication mobile stations, and further reducing the transmission power from the base station to the low-speed communication mobile stations.

In the foregoing wishing path selection methods, by arranging that if a power difference between a path selected by the path selecting method based on arrival angles and a path having the greatest power value is no less than a predetermined value, the path having the greatest power value is selected as a wishing path, while, if it is less than the predetermined value, the path selected by the path selection method based on arrival angles is selected as a wishing path and, if there is no such a path, the path having the greatest power value is selected as a wishing path, there is an effect of improving the interference removing effect and maintaining the gain in the wishing path direction.

Considering the fluctuation of the power values due to fading, the fading fluctuation differs in the down line and the up line, particularly, the fluctuation amount due to fading is greater in the down line. In view of this, in the directivity control system of FIG. 2, because the optimum path fluctuates upon the fading fluctuation, it is desirable to implement the path selection using the long-term average power so as to avoid wrong selection of the path caused by instantaneous power generated by fading.

In the adaptive array antenna, the foregoing wishing path selection is normally carried out when starting communication with mobile stations, such as upon starting up the base station. However, it is not necessary to fix the wishing path to the path that was determined upon starting the communication. For example, in the directivity control system of FIG. 1 or 2, the path selecting section may select regularly the optimum path that changes depending on the communication state, thereby to change the wishing path.

With this arrangement, the interference removing effect can be enhanced depending on changes of the communication state of the high-speed data communication, thereby to maintain the high-quality communication characteristics.

In the directivity control system of FIG. 1 or 2, it is possible that even the optimum path selected in the path selecting section is subjected to deterioration in characteristic due to the propagation path state such as fading.

In the adaptive array antenna, if the quality of the communication characteristics is apparently deteriorated, for example, if given SINR is not satisfied for a long time so that the communication is forcibly disconnected, or if given SINR is not satisfied even if the transmission is continued over several slots with the maximum power in the transmission power control, the selected path may be switched in order of paths having greater power values measured in the power measuring section.

With this arrangement, the interference removing effect can be enhanced depending on changes of the communication state of the high-speed data communication, thereby to maintain the high-quality communication characteristics.

The adaptive array antenna directivity control system according to the embodiment of the present invention is applicable to not only CDMA, but also other radio communication systems by performing communication between base stations to exchange terminal position information, and still exhibits the foregoing effects.

According to the present invention, there is provided an adaptive array antenna directivity control system that controls directivity of an adaptive array antenna provided in a radio base station, and causes signals from a mobile station received at a plurality of antenna elements constituting the adaptive array antenna, to have weights corresponding to the respective antenna elements so as to reduce interference relative to a reception wishing path optimum for receiving signals from the mobile station, wherein paths are detected from the signals received at the antenna elements, a power value and an arrival angle are calculated for each of the detected paths, the reception wishing path is selected from the detected paths based on at least one of the power values and the arrival angles, the weight for reducing the interference relative to the reception wishing path is derived for each of the antenna elements, and the signals received at the antenna elements are multiplied by the corresponding weights. Therefore, the reception wishing path can be selected depending on the state of communication with the mobile station, thereby to improve an interference removing effect of the adaptive array antenna.

According to the present invention, there is also provided an adaptive array antenna directivity control system that controls directivity of an adaptive array antenna provided in a radio base station, and causes signals from a mobile station received at a plurality of antenna elements constituting the adaptive array antenna, to have weights corresponding to the respective antenna elements so as to reduce interference relative to a transmission wishing path optimum for transmitting signals to the mobile station, wherein paths are detected from the signals received at the antenna elements, a power value and an arrival angle are calculated for each of the detected paths, the transmission wishing path is selected from the detected paths based on at least one of the power values and the arrival angles, the weight for reducing the interference relative to the transmission wishing path is derived for each of the antenna elements, and the signals to be transmitted from the antenna elements are multiplied by the corresponding weights. Therefore, the transmission wishing path can be selected depending on the state of communication with the mobile station, thereby to improve an interference removing effect of the adaptive array antenna.

What is claimed is:

1. An adaptive array antenna directivity control system that controls directivity of an adaptive array antenna provided in a radio base station, and causes signals from a mobile station received at a plurality of antenna elements constituting said adaptive array antenna, to have weights corresponding to the respective antenna elements so as to reduce interference relative to a reception wishing path optimum for receiving signals from said mobile station,
wherein paths are detected from the signals received at said antenna elements, a power value and an arrival angle are calculated for each of the detected paths, said reception wishing path is selected from said detected paths based on at least one of said power values and said arrival angles, the weight for reducing the interference relative to said reception wishing path is derived for each of said antenna elements, and the signals received at said antenna elements are multiplied by the corresponding weights.

2. An adaptive array antenna directivity control system according to claim 1, wherein, when the mobile station wishing communication performs low-speed communication, the reception wishing path is selected based on the power values in said paths and, when the mobile station performs high-speed communication, the reception wishing path is selected based on at least one of said power values and said arrival angles in said paths.

3. An adaptive array antenna directivity control system according to claim 1, wherein, when a power difference between the power value in the selected reception wishing path and the power value of the path having the greatest power value within the detected paths is no less than a predetermined value, the path having the greatest power value is selected as a new reception wishing path.

4. An adaptive array antenna directivity control system according to claim 2, wherein, when a power difference between the power value in the selected reception wishing path and the power value of the path having the greatest power value within the detected paths is no less than a predetermined value, the path having the greatest power value is selected as a new reception wishing path.

5. An adaptive array antenna directivity control system comprising:
a plurality of antenna receiving sections comprising a plurality of antenna elements constituting an adaptive array antenna, and receivers corresponding to said antenna elements, respectively, for receiving radio signals from a mobile station according to CDMA communication, converting the received radio signals into baseband signals, and outputting the baseband signals;
a received data processing section for detecting paths of the radio signals based on the baseband signals received at the antenna receiving sections, deriving a power value and an arrival angle relative to the corresponding antenna receiving section for each of the detected paths, selecting a reception wishing path optimum for receiving radio signals from said mobile station, from said detected paths based on at least one of said power values and said arrival angles, and outputting a result of the path detection, the power values and the arrival angles for the respective paths, and a result of the selection of the reception wishing path;
a weight control section for calculating a reception weight for each of said antenna receiving sections for reducing interference relative to the reception wishing path, based on the path detection result, the power value and the arrival angel for each path, and the selection result of the reception wishing path output from said received data processing section, and outputting the reception weights;
a plurality of multipliers provided for said antenna receiving sections, respectively, and implementing multiplication between the received signals output from the corresponding antenna receiving sections and the reception weights for the corresponding antenna receiving sections output from said weight control section; and
an adder for deriving the sum of multiplication results output from said respective multipliers, and outputting the sum as a received signal,
wherein said received data processing section comprises:
a path detecting section for performing despread processing relative to the baseband signals output from said antenna receiving sections, and detecting arrival timings of the signals received at the antenna receiving sections based on a result of the despread processing, thereby to detect said paths;
a power measuring section for calculating the power values for the respective paths based on signals after the despread processing;
an angle estimating section for estimating the arrival angles of the respective paths to the antenna receiving sections based on the signals after the despread processing; and
a path selecting section for selecting the reception wishing path optimum for receiving signals from the mobile station, from the detected paths based on at least one of said power values and said arrival angles.

6. An adaptive array antenna directivity control system according to claim 5, wherein, when the mobile station wishing communication performs low-speed communication, said path selecting section selects the reception wishing path based on the power values in said paths and, when the mobile station performs high-speed communication, said path selecting section selects the reception wishing path based on at least one of said power values and said arrival angles in said paths.

7. An adaptive array antenna directivity control system according to claim 5, wherein, when a power difference between the power value in the selected reception wishing path and the power value of the path having the greatest power value within the detected paths is no less than a predetermined value, said path selecting section selects the path having the greatest power value as a new reception wishing path.

8. An adaptive array antenna directivity control system according to claim 6, wherein, when a power difference between the power value in the selected reception wishing path and the power value of the path having the greatest power value within the detected paths is no less than a predetermined value, said path selecting section selects the path having the greatest power value as a new reception wishing path.

9. An adaptive array antenna directivity control system according to claim 7, wherein, when a reception characteristic of the adaptive array antenna is deteriorated, said path selecting section performs selection of a reception wishing path, and said weight control section calculates a reception weight for each of said antenna receiving sections based on a result of the selection, and outputs the reception weights to the corresponding multipliers.

10. An adaptive array antenna directivity control system according to claim 8, wherein, when a reception characteristic of the adaptive array antenna is deteriorated, said path selecting section performs selection of a reception wishing path, and said weight control section calculates a reception weight for each of said antenna receiving sections based on a result of the selection, and outputs the reception weights to the corresponding multipliers.

11. An adaptive array antenna directivity control system that controls directivity of an adaptive array antenna provided in a radio base station, and causes signals from a mobile station received at a plurality of antenna elements constituting said adaptive array antenna, to have weights corresponding to the respective antenna elements so as to reduce interference relative to a transmission wishing path optimum for transmitting signals to said mobile station,
wherein paths are detected from the signals received at said antenna elements, a power value and an arrival angle are calculated for each of the detected paths, said transmission wishing path is selected from said detected paths based on at least one of said power values and said arrival angles, the weight for reducing the interference relative to said transmission wishing path is derived for each of said antenna elements, and the signals to be transmitted from said antenna elements are multiplied by the corresponding weights.

12. An adaptive array antenna directivity control system according to claim 11, wherein, when the mobile station wishing communication performs low-speed communication, the transmission wishing path is selected based on the power values in said paths and, when the mobile station performs high-speed communication, the transmission wishing path is selected based on at least one of said power values and said arrival angles in said paths.

13. An adaptive array antenna directivity control system according to claim 11, wherein, when a power difference between the power value in the selected transmission wishing path and the power value of the path having the greatest power value within the detected paths is no less than a predetermined value, the path having the greatest power value is selected as a new transmission wishing path.

14. An adaptive array antenna directivity control system according to claim 12, wherein, when a power difference between the power value in the selected transmission wishing path and the power value of the path having the greatest power value within the detected paths is no less than a predetermined value, the path having the greatest power value is selected as a new transmission wishing path.

15. An adaptive array antenna directivity control system comprising:
a plurality of antenna transmitting/receiving sections comprising a plurality of antenna elements constituting an adaptive array antenna, and transmitters and receivers corresponding to said antenna elements, respectively, for receiving radio signals from a mobile station according to CDMA communication, converting the received radio signals into baseband signals, and outputting the baseband signals, while converting baseband signals to be transmitted into radio signals and transmitting the radio signals;
a received data processing section for detecting paths of the radio signals based on the baseband signals received at the antenna transmitting/receiving sections, deriving a power value and an arrival angle relative to the corresponding antenna transmitting/receiving section for each of the detected paths, selecting a transmission wishing path optimum for transmitting radio signals to said mobile station, from said detected paths based on at least one of said power values and said arrival angles, and outputting a result of the path detection, the power values and the arrival angles for the respective paths, and a result of the selection of the transmission wishing path;
a weight control section for calculating a transmission weight for each of said antenna transmitting/receiving sections for reducing interference relative to the transmission wishing path, based on the path detection result, the power value and the arrival angel for each path, and the selection result of the transmission wishing path output from said received data processing section, and outputting the transmission weights;
a distributor for distributing and outputting baseband transmission signals to be transmitted, for said antenna transmitting/receiving sections, respectively; and
a plurality of multipliers provided for said antenna transmitting/receiving sections, respectively, implementing multiplication between the transmission signals output from said distributor and the transmission weights for the corresponding antenna transmitting/receiving sections output from said weight control section, and outputting multiplication results to the corresponding antenna transmitting/receiving sections,
wherein said received data processing section comprises:
a path detecting section for performing despread processing relative to the baseband signals output from said antenna transmitting/receiving sections, and detecting arrival timings of the signals received at the antenna transmitting/receiving sections based on a result of the despread processing, thereby to detect said paths;
a power measuring section for calculating the power values for the respective paths based on signals after the despread processing;
an angle estimating section for estimating the arrival angles of the respective paths to the antenna transmitting/receiving sections based on the signals after the despread processing; and
a path selecting section for selecting the transmission wishing path optimum for transmitting signals to the mobile station, from the detected paths based on at least one of said power values and said arrival angles.

16. An adaptive array antenna directivity control system according to claim 15, wherein, when the mobile station wishing communication performs low-speed communication, said path selecting section selects the transmission wishing path based on the power values in said paths and, when the mobile station performs high-speed communication, said path selecting section selects the transmission wishing path based on at least one of said power values and said arrival angles in said paths.

17. An adaptive array antenna directivity control system according to claim 15, wherein, when a power difference between the power value in the selected transmission wishing path and the power value of the path having the greatest power value within the detected paths is no less than a predetermined value, said path selecting section selects the path having the greatest power value as a new transmission wishing path.

18. An adaptive array antenna directivity control system according to claim 16, wherein, when a power difference between the power value in the selected transmission wishing path and the power value of the path having the greatest power value within the detected paths is no less than a predetermined value, said path selecting section selects the path having the greatest power value as a new transmission wishing path.

19. An adaptive array antenna directivity control system according to claim 17, wherein, when a transmission characteristic of the adaptive array antenna is deteriorated, said path selecting section performs selection of a transmission wishing path, and said weight control section calculates a transmission weight for each of said antenna transmitting/receiving sections based on a result of the selection, and outputs the transmission weights to the corresponding multipliers.

20. An adaptive array antenna directivity control system according to claim 18, wherein, when a transmission characteristic of the adaptive array antenna is deteriorated, said path selecting section performs selection of a transmission wishing path, and said weight control section calculates a transmission weight for each of said antenna transmitting/receiving sections based on a result of the selection, and outputs the transmission weights to the corresponding multipliers.
